(19) United States
(12) Patent Application Publication
(10) Pub. No.: US 2023/0252175 A1
(43) Pub. Date: Aug. 10, 2023

(54) COMPUTER READABLE MEDIUM, USER APPARATUS, ACCESS CONTROL METHOD, AND ACCESS CONTROL SYSTEM

(71) Applicants: NEC Corporation, Minato-ku, Tokyo (JP); NEC Solution Innovators, Ltd., Koto-ku,Tokyo (JP)

(72) Inventors: Takumi Hirota, Tokyo (JP); Hideyuki Yasuoka, Tokyo (JP)

(73) Assignees: NEC Corporation, Minato-ku, Tokyo (JP); NEC Solution Innovators, Ltd., Koto-ku,Tokyo (JP)

(21) Appl. No.: 18/009,027

(22) PCT Filed: Jun. 11, 2020
(86) PCT No.: PCT/JP2020/023092

§ 371 Date: Dec. 8, 2022

(51) Int. Cl. G06F 21/62; H04L 9/08

(52) U.S. Cl. CPC G06F 21/6218; H04L 9/0822; G06F 2221/2141

(57) ABSTRACT

A user apparatus (2000) acquires an access right information (20) from a first server apparatus (3000) and determines whether or not a target user (40) has an access right for a target file (10). The user apparatus (2000) acquires key information (30) for the target file (10) from a second server apparatus (4000) when the target user (40) has the access right for the target file (10). The user apparatus (2000) decrypts the target file (10) by using the key information (30).

### TECHNICAL FIELD

The present invention relates to control of access to files.

### BACKGROUND ART

Technologies for enabling a plurality of users to share files through a network are now being developed. Further, in such file sharing, encryption of files and control of access thereto based on the access right therefor are performed in order to prevent unauthorized use or the like of the files.

As prior-art literature disclosing a technology for realizing management of such shared files, for example, there is PTL1. PTL1 discloses a system for controlling access to a file by a user apparatus. When the user apparatus accesses an encrypted shared file, it requests a decryption key from a management server. Upon receiving the request, the management server acquires, from an associated server, information about the access right for a shared folder in which the shared file is stored. The management server transmits a decryption key and the information about the access right to the user apparatus. The user apparatus uses the shared file by using the acquired decryption key in accordance with the access right indicated in the acquired information about the access right.

### CITATION LIST

### Patent Literature

PTL1: International Patent Publication No. WO2017/064780

### SUMMARY OF INVENTION

### Technical Problem

In the system disclosed in PTL1, the information about the access right and the decryption key are acquired through one server called the management server. Therefore, loads are concentrated on the management server and hence the loads on the management server increase.

The present invention has been made in view of the above-described problem, and an objective thereof is to provide a technology for preventing, in an environment in which files are shared by using a server, loads from being concentrated on one server.

### Solution to Problem

A user apparatus according to the present invention includes: a determination unit configured to acquire access right information about an access right of a target user for an encrypted target file from a first server apparatus, and thereby determine whether or not the target user has an access right for the target file; an acquisition unit configured to acquire key information from a second server apparatus when it is determined that the target user has the access right for the target file, the key information being information used to decrypt the target file; and a decryption unit configured to decrypt the target file by using the acquired key information.

An access control method according to the present invention is performed by a computer. The access control method includes: a determination step of acquiring access right information about an access right of a target user for an encrypted target file from a first server apparatus, and thereby determining whether or not the target user has an access right for the target file; an acquisition step of acquiring key information from a second server apparatus when it is determined that the target user has the access right for the target file, the key information being information used to decrypt the target file; and a decryption step of decrypting the target file by using the acquired key information. The computer is neither the first server apparatus nor the second server apparatus.

A computer readable medium according to the present invention stores a program for causing a computer to perform an access control method according to the present invention.

An access control system according to the present invention includes a user apparatus, a first server apparatus, and a second server apparatus. The user apparatus includes: a determination unit configured to transmit, to the first server apparatus, a first request requesting access right information about an access right of a target user for an encrypted target file, and determine whether or not the target user has the access right for the target file by using the access right information acquired from the first server apparatus; an acquisition unit configured to transmit, when it is determined that the target user has the access right for the target file, a second request requesting key information to the second server apparatus, and acquire the key information from the second server apparatus, the key information being information used to decrypt the target file; and a decryption unit configured to decrypt the target file by using the acquired key information.

The first server apparatus provides the access right information to the user apparatus in response to the first request.

The second server apparatus provides the key information to the user apparatus in response to the second request.

### Advantageous Effects of Invention

A technology for preventing, in an environment in which files are shared by using a server, loads from being concentrated on one server is provided.

### BRIEF DESCRIPTION OF DRAWINGS

FIG. 1 shows an example of an overview of operations performed by a user apparatus according to a first example embodiment;

FIG. 2 is a block diagram showing an example of a functional configuration of an access control system according to the first example embodiment;

FIG. 3 is a block diagram showing an example of a hardware configuration of a computer that implements a user apparatus;

FIG. 4 is a flowchart showing an example of a flow of processes performed by the user apparatus according to the first example embodiment;

FIG. 5 is a diagram for conceptually explaining access control based on a reference location;

FIG. 6 shows a specific example of implementation of an access control system; and

FIG. 7 shows an example of a flow of access control performed in the example of the implementation of the access control system.

### EXAMPLE EMBODIMENT

An example embodiment according to the present disclosure will be described hereinafter in detail with reference to the drawings. The same reference numerals (or symbols) are assigned to the same or corresponding components throughout the drawings, and redundant descriptions thereof are omitted as appropriate for clarifying the explanation.

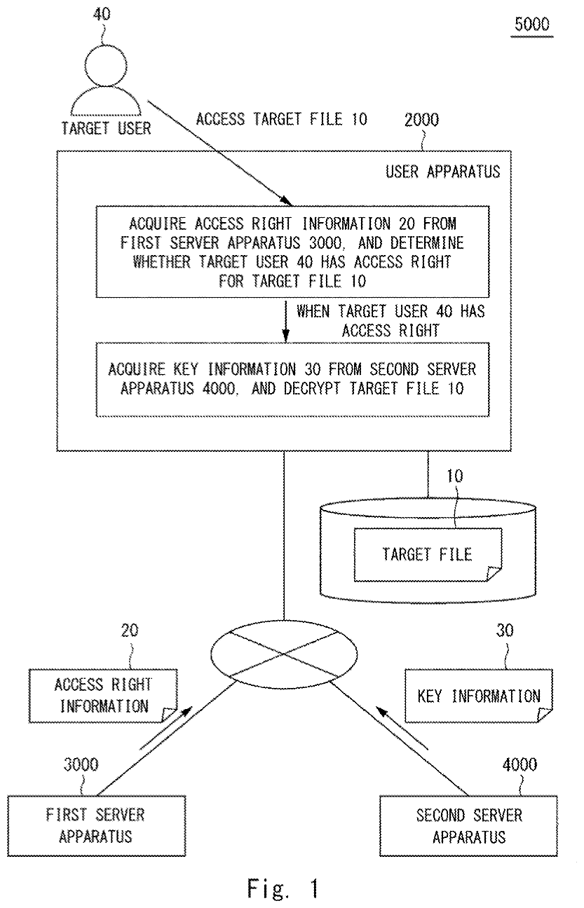

FIG. 1 shows an example of an overview of operations performed by a user apparatus 2000 according to a first example embodiment. Note that FIG. 1 is a diagram for facilitating understanding of the overview of the user apparatus 2000, and the operations performed by the user apparatus 2000 are not limited to those shown in FIG. 1.

The user apparatus 2000, together with a first server apparatus 3000 and a second server apparatus 4000, constitutes an access control system 5000. In the access control system 5000, access to a file made by the user apparatus 2000 is controlled based on the access right thereof.

Note that among the files accessed by the user apparatus 2000, a file for which access control using the access control system 5000 is performed is called a target file 10. The storage device in which the target file 10 is stored may be any storage device accessible from the user apparatus 2000, and may be disposed either inside or outside the user apparatus 2000.

Further, the target file 10 is stored in an encrypted state in the storage device. Therefore, in the access control system 5000, in addition access to the target file 10 being controlled therein, the decryption of the target file 10 is also performed therein.

The user apparatus 2000 is an apparatus that is used by a user and that accesses the target file 10. Note that the user using the user apparatus 2000 is called a target user 40. The access to the target file 10 may be performed in response to an operation being performed by the target user 40, or may be automatically performed by software running on the user apparatus 2000. FIG. 1 shows an example case in which access to the target file 10 is performed in response to an operation being performed by the target user 40. The first server apparatus 3000 is an apparatus that manages information about the access right for the target file 10. The second server apparatus 4000 is a server apparatus that manages information necessary for decrypting the target file 10.

When the target file 10 is used in the user apparatus 2000, the user apparatus 2000 accesses the first server apparatus 3000 and thereby determines whether or not the target user 40 has a right to access the target file 10 (i.e., an access right for the target file 10). More specifically, the user apparatus 2000 acquires, from the first server apparatus 3000, information about the access right for the target file 10 (hereinafter, called access right information 20), and determines whether or not the target user 40 has the access right for the target file 10 by using the acquired access right information 20.

When the target user 40 has the access right for the target file 10, the user apparatus 2000 accesses the second server apparatus 4000 and decrypts the target file 10. More specifically, the user apparatus 2000 acquires, from the second server apparatus 4000, information necessary for decrypting the target file 10 (hereinafter, called key information 30). Then, the user apparatus 2000 decrypts the target file 10 by using the key information 30. For example, the key information 30 contains a decryption key for decrypting the target file 10. In this case, the user apparatus 2000 decrypts the target file 10 by using the decryption key contained in the key information 30. However, the data contained in the key information 30 is not limited to the decryption key.

### Example of Function and Effect

According to the access control system 5000 in accordance with this example embodiment, the access control and the decryption of the target file 10, which is the target of the access control and is encrypted, are performed using different servers. More specifically, the access control is performed by using the first server apparatus 3000, and the decryption of the target file 10 is performed by using the second server apparatus 4000. Accordingly, regarding access to files for which both access control and decryption need to be performed, it is possible to prevent the processing loads from being concentrated on one type of server.

The user apparatus 2000 according to this example embodiment will be described hereinafter in a more detailed manner.

### Example of Advantageous Effect

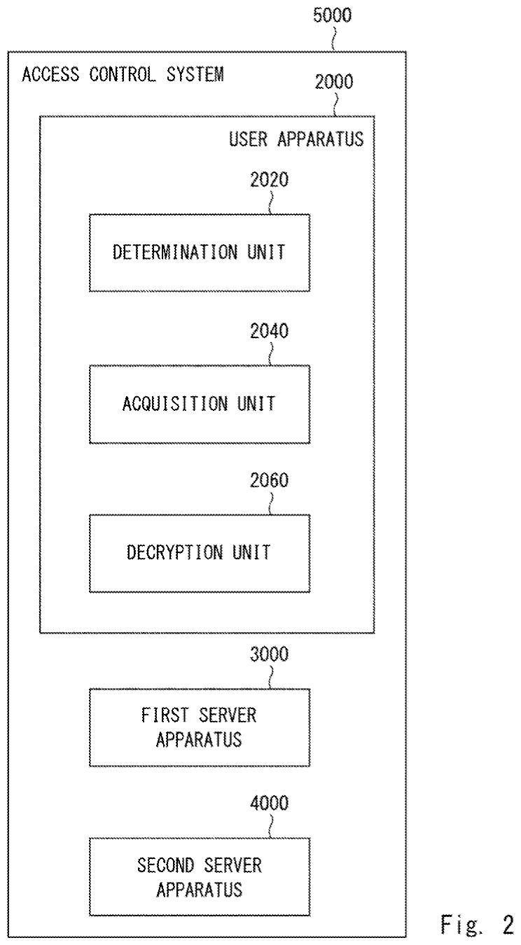

FIG. 2 is a block diagram showing an example of a functional configuration of the user apparatus 2000 according to the first example embodiment. As described above, the user apparatus 2000, together with the first and second server apparatuses 3000 and 4000, constitutes the access control system 5000. The user apparatus 2000 include a determination unit 2020, an acquisition unit 2040, and a decryption unit 2060. The determination unit 2020 acquires access right information 20 from the first server apparatus 3000, and determines whether or not the target user 40 has an access right for the target file 10. When the target user 40 has the access right for the target file 10, the acquisition unit 2040 acquires key information 30 for the target file 10 from the second server apparatus 4000. The decryption unit 2060 decrypts the target file 10 by using the key information 30.

### Example of Hardware Configuration

Each functional component of the user apparatus 2000 may be implemented by hardware (e.g., a hard-wired electronic circuit) that realizes the functional component, or by a combination of hardware and software (e.g., a combination of an electronic circuit and a program for controlling the electronic circuit). An example case where each functional component of the user apparatus 2000 is implemented by a combination of hardware and software will be further described hereinafter.

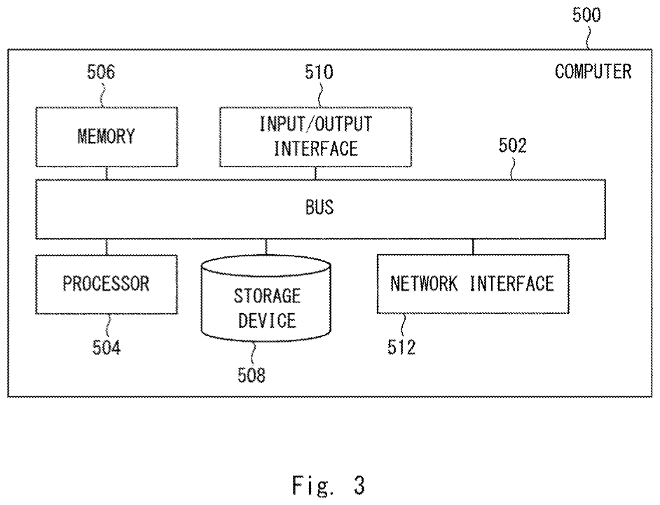

FIG. 3 is a block diagram showing an example of a hardware configuration of a computer 500 that implements the user apparatus 2000. The computer 500 is any type of computer. For example, the computer 500 is a stationary computer such as a PC (Personal Computer) or a server machine. Alternatively, the computer 500 is, for example, a mobile computer, such as a smartphone or a tablet device. The computer 500 may be a special-purpose computer designed to implement the user apparatus 2000, or may be a general-purpose computer.

For example, each function of the user apparatus 2000 is implemented by the computer 500 by installing a certain application program in the computer 500. The aforementioned application is implemented by a program for implementing the functional components of the user apparatus 2000.

The computer 500 includes a bus 502, a processor 504, a memory 506, a storage device 508, an input/output interface 510, and a network interface 512. The bus 502 is a data transmission path through which the processor 504, the memory 506, the storage device 508, the input/output interface 510, and the network interface 512 transmit and receive data to and from each other. However, the method for connecting the processor 504 and the like to each other is not limited to connections through buses.

The processor 504 is one of various types of processors, such as a CPU (Central Processing Unit), a GPU (Graphics Processing Unit), or an FPGA (Field-Programmable Gate Array). The memory 506 is a primary storage device implemented by using a RAM (Random Access Memory) or the like. The storage device 508 is a secondary storage device implemented by using a hard disk drive, an SSD (Solid State Drive), a memory card, or a ROM (Read Only Memory).

The input/output interface 510 is an interface for connecting the computer 500 with an input/output device. For example, an input device such as a keyboard and an output device such as a display device are connected to the input/output interface 510.

The network interface 512 is an interface for connecting the computer 500 to a network. The network may be a LAN (Local Area Network) or a WAN (Wide Area Network).

The storage device 508 stores a program for implementing each functional component of the user apparatus 2000 (a program for implementing the above-described application). The processor 504 implements each functional component of the user apparatus 2000 by loading the program into the memory 506 and executing the loaded program. Further, the target file 10 may be stored in the storage device 508.

The user apparatus 2000 may be implemented by one computer 500, or may be implemented by a plurality of computers 500. In the latter case, the configurations of the computers 500 do not necessarily have to be identical to each other, and may be different from each other.

Similarly to the user apparatus 2000, each of the first and second server apparatuses 3000 and 4000 is also implemented by various computers. Each of the computer that implements the first server apparatus 3000 and the computer that implements the second server apparatus 4000 has, for example, the hardware configuration shown in FIG. 3, like the computer 500 that implements the user apparatus 2000. However, the hardware configurations of the computers implementing the user apparatus 2000, the first server apparatus 3000, and the second server apparatus 4000 may be different from one another. Further, each of the first and second server apparatuses 3000 and 4000 may be implemented by a plurality of computers.

The computers implementing the user apparatus 2000, the first server apparatus 3000, and the second server apparatus 4000 are connected to each other through a network so that they can communicate with each other. The network connecting them to each other may be a LAN or a WAN. Further, two of these three apparatuses may be connected to each other by a LAN, and they may be connected to the remaining one through a WAN. For example, the first sever apparatus 3000 and the second server apparatus 4000 are provided in the same LAN, and the user apparatus 2000 is connected to the first server apparatus 3000 and the second server apparatus 4000 through a WAN.

### Flow of Processes

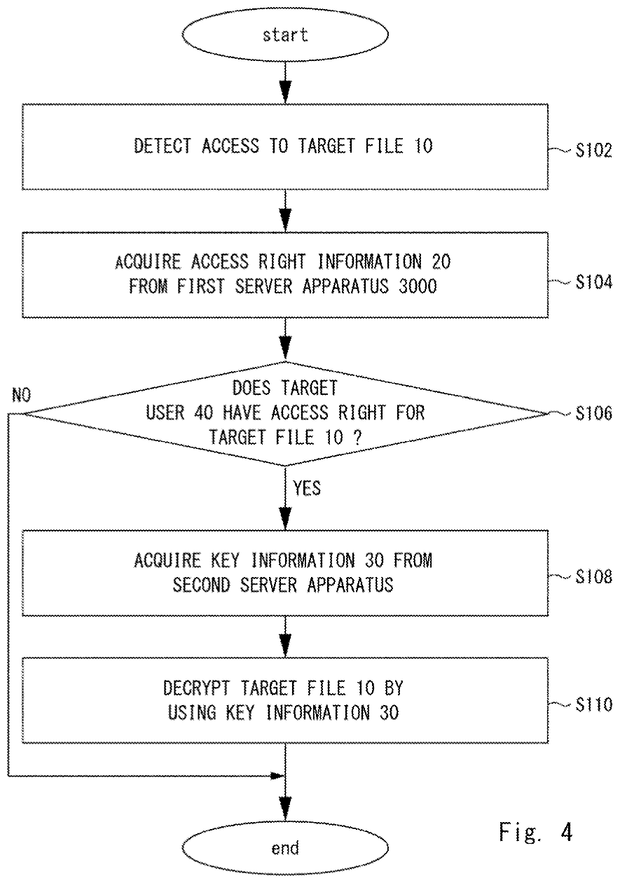

FIG. 4 is a flowchart showing an example of a flow of processes performed by the user apparatus 2000 according to the first example embodiment. The determination unit 2020 detects access to the target file 10 (S102). The determination unit 2020 acquires access right information 20 from the first server apparatus 3000 (S104). The determination unit 2020 determines whether or not the target user 40 has an access right for the target file 10 by using the access right information 20 (S106). When the target user 40 has the access right for the target file 10 (S106: Yes), the acquisition unit 2040 acquires key information 30 from the second server apparatus 4000 (S108). The decryption unit 2060 decrypts the target file 10 by using the key information 30 (S110).

Note that an arbitrary process may be performed when it is determined that the target user 40 does not have the access right for the target file 10 (S106: No). When access to the target file 10 is made in response to a user operation, for example, the user apparatus 2000 outputs, to a display device or the like viewed by the target user 40, an error message or the like indicating that access to the target file 10 is not permitted due to a lack of the access right therefor. Further, when access to the target file 10 is made by software running on the user apparatus 2000, for example, the user apparatus 2000 notifies the software of an error indicating that the software does not have the access right for the target file 10.

### Detection of Access to Target File 10: S102

When access to the target file 10 is being made, it is determined whether or not the target user 40 has the access right for the target file 10. Therefore, the determination unit 2020 detects the access to the target file 10 (S102). Note that various well-known techniques can be employed for detecting access to a file for which certain control is to be performed.

For example, the user apparatus 2000 detects access to a given file and determines whether or not that file is the target file 10. This determination can be made, for example, by referring to metadata of the accessed file. For example, a specific flag is provided in the metadata of the target file 10 (i.e., the metadata of a file for which access control is performed by the access control system 5000). When access to a file is detected, the determination unit 2020 determines whether or not the above-described flag is contained in the metadata of that file. When the above-described flag is contained in the metadata of the accessed file, the determination unit 2020 determines that the accessed file is the target file 10. On the other hand, when the above-described flag is not contained in the metadata of the accessed file, the determination unit 2020 determines that the accessed file is not the target file 10.

Alternatively, metadata other the above-described flag may be used to determine whether or not the accessed file is the target file 10. For example, the metadata of the target file 10 may contain information indicating a reference location (which will be described later), or an encryption key used to encrypt the target file 10. In this way, it is possible to use the aforementioned information in a manner similar to that for the above-described flag.

Further, for example, the directory in which the target file 10 can be stored may be limited to a certain directory (hereinafter, called a target directory). In this case, when access to a file is detected, the determination unit 2020 determines whether or not that file is stored in the target directory. When the accessed file is stored in the target directory, the determination unit 2020 determines that the file is the target file 10. On the other hand, when the accessed file is not stored in the target directory, the determination unit 2020 determines that the file is not the target file 10. Note that there may be a plurality of target directories.

Information defining the target directory is stored, for example, in a storage device accessible from the user apparatus 2000. In another example, the metadata of a directory may include a flag indicating that the directory is the target directory.

### As to Access Right

Access rights managed by the first server apparatus 3000 will be described hereinafter. An access right may be set for each user or for each group of users. Further, an access right may be individually set for each of various types of operations performed for a file, or collectively set for all types of the operations.

An access right may be set for each file or for each group of files. In the latter case, for example, an access right is set for a location (a directory) where files are stored. That is, the same access right is set for the target files 10 stored in the same directory. Note that when a sub-directory is stored in a directory for which an access right is set, it is preferable that the same access right is set for files and sub-directories stored in that sub-directory in a recursive manner.

Note that in the case where, for a given file, there are an access right individually set for this file and an access right set for a group to which this file belongs, how to handle the access to the file is arbitrarily determined. For example, only one of the two types of access rights is applied.

Note that in the case where an access right is set for a directory, the access right for a given file may be an access right that is set for a directory in which this file was stored in the past (hereinafter, called a reference location), instead of an access right that is set for a directory in which this file is currently stored. For example, assume that a target file 10 stored in a file server is copied to the user apparatus 2000. Then, after that, the user apparatus 2000 accesses the target file 10 stored in the user apparatus 2000. In this case, it is possible that the location in the file server in which the target file 10 is stored may be set as the reference location of the target file 10. In such a situation, by using the access right set for the reference location, it is possible to carry out access control based on the access right set for the location in the file server in which the target file 10 was stored even after the target file 10 is copied to the user apparatus 2000.

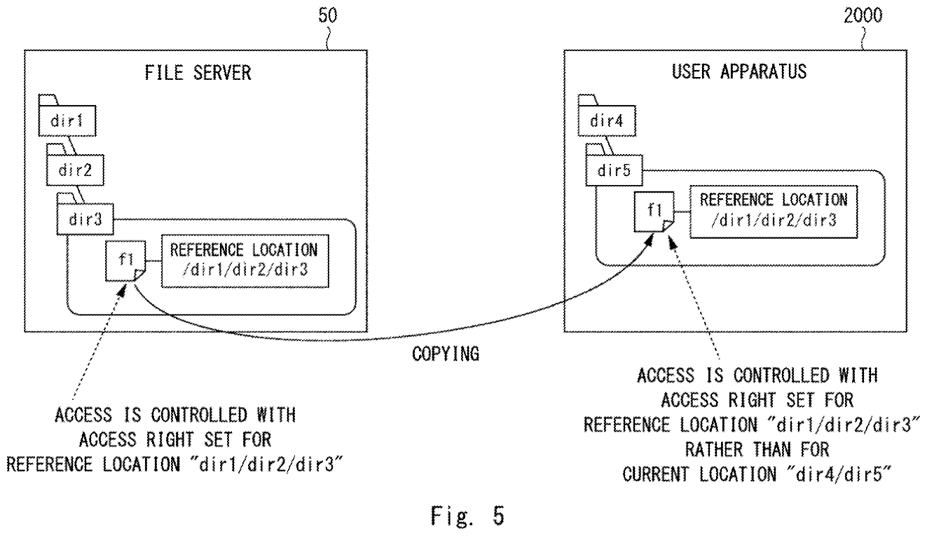

FIG. 5 is a diagram for conceptually explaining access control based on the reference location. In FIG. 5, a file f1 is stored in a directory “/dir1/dir2/dir3” provided in a file server 50. Further, the directory “/dir1/dir2/dir3” in the file server 50 is set as the reference location of the file f1.

Further, in FIG. 5, the file f1 has been copied from the directory “/dir1/dir2/dir3” in the file server 50 to a directory “/dir4/dir5” in the user apparatus 2000. In this case, when the target file 10 copied to the user apparatus 2000 is accessed, the access to the target file 10 is controlled based on the access right set for the directory “/dir1/dir2/dir3” in the file server 50, which is the reference location, rather than the directory “/dir4/dir5” in the user apparatus 2000, which is the location where the target file 10 is currently stored. Therefore, for example, even if the target user 40, who is operating the user apparatus 2000, has an access right for the file stored in the directory “/dir4/dir5”, the target user 40 cannot access the target file 10 stored in the directory “/dir4/dir5” unless she/he has an access right for the directory “/dir1/dir2/dir3”.

Further, assume that the file f1 is deleted in the file server 50. In this case, the system may be configured so that the file f1 copied to the user apparatus 2000 cannot be accessed even by the target user 40 having the access right for the reference location of the file f1. To realize the above-described operation, it is necessary to be able to find out which file in the file server 50 corresponds to the file copied to the user apparatus 2000. Various well-known methods can be adopted to realize the above-described finding of the file. For example, the path of the file in the file server 50, which is the original data of the file copied to the user apparatus 2000, is contained in the metadata of the file copied to the user apparatus 2000. Further, when it is determined whether or not the target user 40 has the access right for the target file 10, it is also determined whether or not the file in the file server 50, which is the original data of the target file 10, has been deleted. Then, when the file has already been deleted, it is determined that the target user 40 does not have the access right.

Note that the reference location of the target file 10 can be updated. For example, the right to change the reference location of the target file 10 is given to a certain user. Suppose that the target file 10 stored in the file server 50 has been moved to another directory in the file server 50 by this user in this case. In this process, for example, the file server 50 ask the user to select whether or not to change the reference location of the moved target file 10 to the directory to which the target file 10 has been moved. When it is selected to change the reference location, the first server apparatus 3000 sets the directory to which the target file 10 has been moved as a new reference location of the moved target file 10. On the other hand, when it is selected not to change the reference location, the reference location is not changed. Note that the first server apparatus 3000 may not ask the user to select whether or not to change the reference location. In this case, when the target file 10 is moved by the user who has the right to change the reference location, the reference location of the target file 10 is automatically changed.

Note that the system may be configured so that, the user can perform, in addition to the normal move operation, an additional move operation that involves the change of the reference location. In this case, when the normal move operation is performed for the target file 10, the reference location of the target file 10 is not changed. On the other hand, when the move operation involving the change of the reference location is performed, the reference location of the target file 10 is changed to the directory to which the target file 10 has been moved.

Note that an arbitrary method can be adopted for the method for enabling the two types of move operations, i.e., the normal move operation and the move operation involving the change of the reference location. For example, there is a possible way in which a move operation performed by using a left button of a mouse is handled as the normal move operation, while a move operation performed by using a right button of the mouse is handled as the move operation involving the change of the reference location.

Note that although the case in which the reference location is updated in response to a file being moved has been descried in the above description, the reference location may be updated in a similar manner in response to a file being copied. In this case, reference locations deferent from each other may be set for the two files containing the same contents. That is, the reference location for the original file is not changed, whereas the directory to which the file has been copied is set as the reference location for the file generated by the copy operation.

### Determination of Access Right: S104, S106

The determination unit 2020 acquires access right information 20 (S104). More specifically, the determination unit 2020 transmits a request for access right information 20 to the first server apparatus 3000. Then, the determination unit 2020 receives the access right information 20 as a response transmitted from the first server apparatus 3000 in response to the above-described request. Then, the determination unit 2020 determines whether or not the target user 40 has an access right by using the access right information 20.

Note that access right information 20 may be 1) information indicating the result of the determination as to whether or not the target user 40 has the access right for the target file 10, or 2) information that can be used to determine whether or not the target user 40 has the access right for the target file 10. Each of those cases are described in detail hereinafter.

### Case of 1)

In this case, the first server apparatus 3000 acquires necessary information from the determination unit 2020 and determines whether or not the target user 40 has an access right for the target file 10. By configuring the system so that the first server apparatus 3000 determines the access right as described above, the amount of information related to the access right handled by the user apparatus 2000 can be reduced.

For example, a storage device (hereinafter, called a first storage device) accessible from the first server apparatus 3000 may store information that associates identification information of a user, identification information (e.g., a path) of a file or a directory that the user identified by the identification information can access, and the type of access (read, write, execution, or the like) that the user is permitted to perform for the file or the directory with each other. Note that a user group may be used instead of the user.

The determination unit 2020 transmits, to the first server apparatus 3000, a request indicating identification information of the target file 10, identification information of the target user 40, and the type of the detected access. The first server apparatus 3000 receives the aforementioned request and determines the access right by using the identification information of the target file 10, the identification information of the target user 40, and the type of access indicated in the request. For example, the first server apparatus 3000 determines whether or not access to the target file 10 by the target user 40 is permitted by comparing the association of “the identification information of the target user 40, the identification information of the target file 10, and the type of the access” indicated in the request with the association of “identification information of a user, identification information of a file or a directory, and a type of permitted access” stored in the first storage device.

The method for realizing the above-described comparison is arbitrarily determined. For example, the first server apparatus 3000 specifies the type of access that the target user 40 is permitted for the target file 10 by searching information stored in the first storage device by using the combination of “the identification information of the target user 40 and the identification information of the target file 10” indicated in the request. Then, the first server apparatus 3000 determines whether or not the type of access indicated in the request is included in the type of access that the target user 40 is permitted for the target file 10. When the type of access indicated in the request is included in the type of permitted access, the first server apparatus 3000 determines that “the target user 40 has the access right”. On the other hand, when the type of access indicated in the request is not included in the type of permitted access, the first server apparatus 3000 determines that “the target user 40 does not have the access right”. Then, the first server apparatus 3000 generates access right information 20 indicating the result of the determination and transmits the generated access right information 20 to the determination unit 2020.

The determination unit 2020 determines whether or not the determination result indicated in the received access right information 20 is a determination result indicating that “the target file 10 has the access right”. When the determination result indicating that “the target file 10 has the access right” is indicated, the determination unit 2020 determines that “the target user 40 has the access right”. On the other hand, when the determination result indicating that “the target file 10 has the access right” is not indicated, the determination unit 2020 determines that “the target user 40 does not have the access right”.

Note that, as described above, there are cases where the reference location is used for the determination of an access right. In this case, the reference location is used instead of the identification information of the target file 10 in the above-described method. For example, the determination unit 2020 transmits a request containing a combination “the identification information of the target user 40, the reference location, and the type of access” to the first server apparatus 3000. The first server apparatus 3000 specifies the type of access that the target user 40 is permitted for the reference location by searching the first storage device by using the combination of “the identification information of the target user 40 and the reference location” indicated in the request. When the type of access indicated in the request is included in the type of access that the target user 40 is permitted for the reference location, a determination result indicating that “the target user 40 has the access right” is obtained. On the other hand, when the type of access indicated in the request is not included in the type of access that the target user 40 is permitted for the reference location, a determination result indicating that “the target user 40 does not have the access right” is obtained.

### Case of 2)

In this case, the access right information 20 is, for example, information indicating a file or a directory that the target user 40 can access. For example, the determination unit 2020 transmits a request indicating the identification information of the target user 40 to the first server apparatus 3000. The first server apparatus 3000 specifies at least one combination of “a file or a directory that the target user 40 can access and the type of access permitted for the file or the directory” by searching the first storage device by using the identification information of the target user 40 indicated in the request. Then, the first server apparatus 3000 transmits information indicating the above-described specified combination as the access right information 20 to the user apparatus 2000.

The user apparatus 2000 determines whether or not the access being made to the target file 10 is permitted to the target user 40 by comparing the combination of “the identification information of the target file 10 and the type of access being made to the target file 10” with the access right information 20. For example, the determination unit 2020 determines whether or not there is identification information corresponding to the identification information of the target file 10 in the identification information of the file or the directory indicated in the access right information 20. Note that the fact that “the identification information of a directory corresponds to the identification information of the target file 10” means that the target file 10 is stored in this directory.

When there is no identification information corresponding to the identification information of the target file 10 in the identification information of the file or the directory indicated in the access right information 20, the determination unit 2020 determines that “the target user 40 does not have the access right”. On the other hand, when there is identification information corresponding to the identification information of the target file 10 in the identification information of the file or the directory indicated in the access right information 20, the determination unit 2020 determines whether or not the type of access being made to the target file 10 is included in the type of access associated with the file or the directory (i.e., the type of permitted access). When it is included, the determination unit 2020 determines that “the target user 40 has the access right”. On the other hand, when it is not included, the determination unit 2020 determines that “the target user 40 does not have the access right”.

In another example, the determination unit 2020 may transmit a request indicating the identification information of the target file 10 to the first server apparatus 3000. In this case, the first server apparatus 3000 specifies at least one combination of “the identification information of the user, and the type of access that this user is permitted for the target file 10” by searching the first storage device by using the identification information of the target file 10 indicated in the request. That is, for each user who is permitted to perform some kind of access to the target file 10, association between the identification information of the user and the type of access permitted to this user is obtained.

The first server apparatus 3000 transmits information indicating the above-described specified combination as the access right information 20 to the user apparatus 2000. The user apparatus 2000 determines whether or not the access being made to the target file 10 is permitted to the target user 40 by comparing the combination of “the identification information of the target user 40, and the type of access made to the target file 10” with the access right information 20.

Note that, in the case of 2), the reference location may also be used for the determination of an access right as described above. In this case, the reference location is used instead of the identification information of the target file 10 in the above-described method. For example, assume that the determination unit 2020 acquires access right information 20 indicating a combination “the file or the directory that the target user 40 can access, and the type of permitted access” by transmitting the identification information of the target user 40 to the first server apparatus 3000. In this case, when there is identification information corresponding to the reference location in the identification information of the file or the directory indicated in the access right information 20, and the type of access being made to the target file 10 is included in the type of access associated with the identification information of the file or the directory, it is determined that “the target user 40 has the access right”. On the other hand, when there is no identification information corresponding to the reference location in the identification information of the file or the directory indicated in the access right information 20, or the type of access being made to the target file 10 is not included in the type of access associated with the file or the directory corresponding to the reference location, it is determined that “the target file 10 does not have the access right”.

### Decryption of Target File 10: S108, S110

When it is determined that the target user 40 has the access right, the acquisition unit 2040 acquires key information 30 from the second server apparatus 4000 (S108). Then, the decryption unit 2060 decrypts the target file 10 by using the key information 30.

The key information 30 may be 1) a decryption key used to decrypt the target file 10, or 2) information that can be used to generate the decryption key. An example of each of these cases will be shown hereinafter in detail.

### Case of 1)

In this case, the second server apparatus 4000 transmits key information 30 containing a decryption key for decrypting the target file 10 to the user apparatus 2000 in response to a request from the acquisition unit 2040. Assume that, for example, the decryption key for decrypting the target file 10 can be generated from the encryption key used to encrypt the target file 10. In this case, the acquisition unit 2040 transmits a request containing the encryption key used to encrypt the target file 10 to the second server apparatus 4000. The second server apparatus 4000 generates a decryption key from the encryption key included in the request. Then, the second server apparatus 4000 generates key information 30 containing the generated decryption key and transmits the generated key information 30 to the user apparatus 2000.

The method by which the user apparatus 2000 acquires the encryption key used to encrypt the target file 10 is arbitrarily determined. For example, the encryption key used to encrypt the target file 10 is stored together with the target file 10 in a storage device accessible from the user apparatus 2000 (e.g., stored as one of the metadata of the target file 10).

Note that the data used to generate the decryption key is not limited to the encryption key and can be any data.

Further, the decryption key corresponding to the encryption key may be stored in advance in a storage device accessible from the second server apparatus 4000. In this case, the second server apparatus 4000 acquires the decryption key by searching the aforementioned storage device by using the encryption key included in the request, and transmits key information 30 containing the acquired decryption key to the user apparatus 2000.

The decryption unit 2060 decrypts the target file 10 by using the decryption key contained in the key information 30 which has been acquired by any of the above-described various methods. Note that well-known techniques can be used for a technique for decrypting an encrypted file by using a decryption key.

### Case of 2)

In this case, the decryption unit 2060 has a function of obtaining a decryption key by using key information 30. Assume that, for example, a decryption key can be generated from an encryption key as described above. For example, in this case, the identification information of the target file 10 and the encryption key used to encrypt the target file 10 are associated with each other and stored in a storage device accessible from the second server apparatus 4000.

The acquisition unit 2040 transmits a request indicating the identification information of the target file 10 to the second server apparatus 4000. The second server apparatus 4000 acquires an encryption key corresponding to the received identification information of the target file 10 from the storage device, and generates key information 30 including the encryption key. Then, the second server apparatus 4000 transmits the generated the key information 30 to the user apparatus 2000.

The decryption unit 2060 generates a decryption key from the encryption key contained in the key information 30. Then, the decryption unit 2060 decrypts the target file 10 by using the generated decryption key.

### Processing After Decryption

The user apparatus 2000 can make the access of the type detected in the step S102 for the decrypted the target file 10. For example, when the operation performed for the target file 10 is reading, the user apparatus 2000 can read the contents of the decrypted target file 10. Further, for example, when the operation performed for the target file 10 is writing, the user apparatus 2000 can make a change to the contents of the decrypted target file 10.

### Specific Example of Implementation of Access Control System 5000

In order to further facilitate the understanding of the access control system 5000, a specific example of the implementation of the access control system 5000 will be described hereinafter. However, the example of the implementation described below is merely an example of a specific embodiment of the access control system 5000, and the specific method for implementing the access control system 5000 is not limited to the example described below.

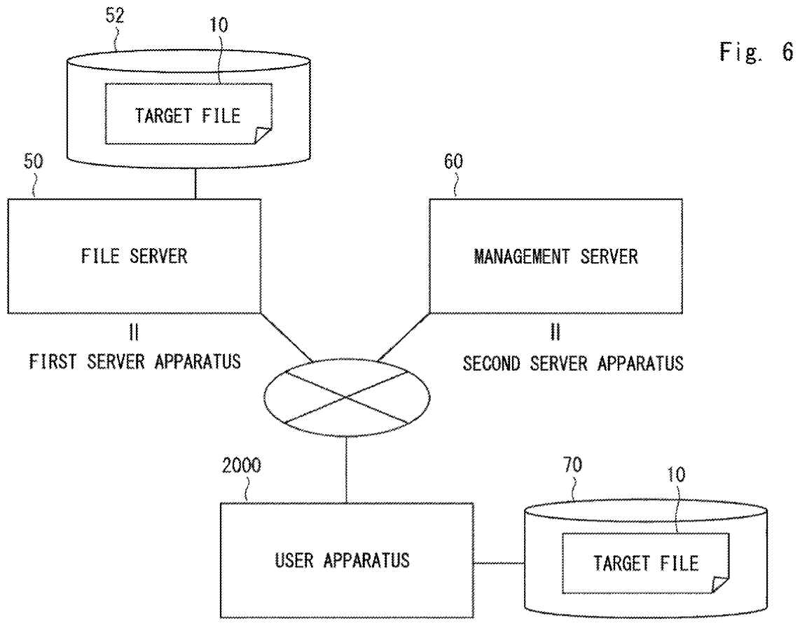

FIG. 6 shows a specific example of the implementation of the access control system 5000. In this example of the implementation, a file server 50 and a management server 60 are provided as apparatuses that function as the first server apparatus 300 and the second server apparatus 4000, respectively. In the example shown below, the access control for the target file 10 is performed based on the reference location set for the target file 10. Further, the decryption key for the target file 10 is generated by using the encryption key used to encrypt the target file 10.

The file server 50 accepts the upload of a file. The file uploaded to the file server 50 is subject to access control performed by the access control system 5000 (i.e., regarded as the target file 10). For example, the target file 10 is uploaded from the user apparatus 2000.

The target file 10 uploaded to the file server 50 is stored in a storage device 52. Note that the target file 10 stored in the storage device 52 is encrypted by the management server 60. For example, the management server 60 acquires the target file 10 uploaded from the user apparatus 2000 to the file server 50, and encrypts the acquired target file 10. When doing so, the management server 60 adds an encryption key to the metadata of the file. The management server 60 transmits the encrypted target file 10 to the file server 50.

The file server 50 stores the target file 10 received from the management server 60 in the storage device 52. Note that the directory in which the target file 10 should be stored is designated by the user apparatus 2000 which has uploaded the target file 10. The file server 50 adds data representing the reference location to the metadata of the target file 10 to be stored in the storage device 52. The reference location in this process represents the path of the directory in which the target file 10 is stored.

The user apparatus 2000 can access the target file 10 managed by the file server 50 (i.e., stored in the storage device 52). Further, the user apparatus 2000 can also download the target file 10 managed by the file server 50 and store the downloaded target file 10 in a storage device 70 accessible from the user apparatus 2000. Note that since the access control is performed based on the reference location as described above, the access control for the downloaded target file 10 can be also performed based on the reference location.

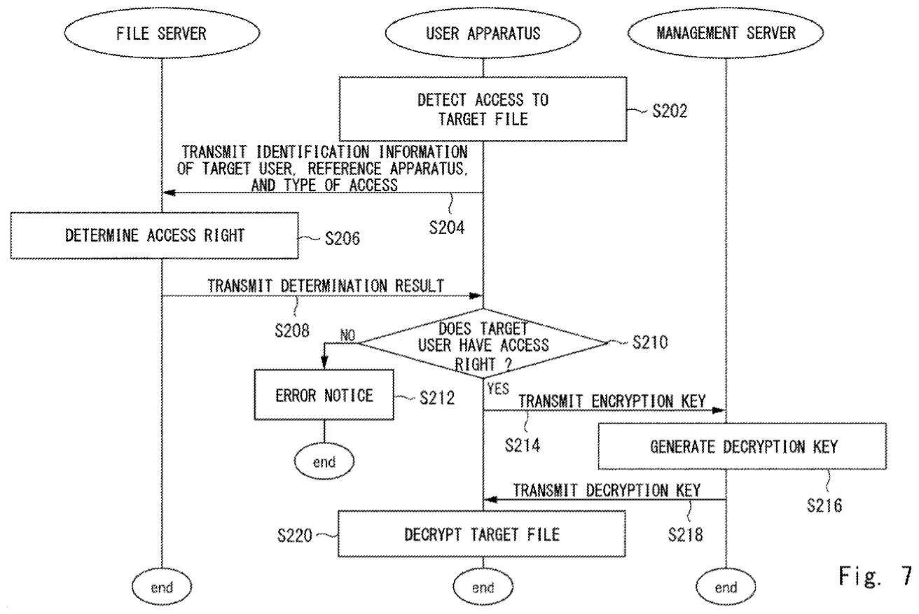

For example, the access control is performed along the following flow. FIG. 7 shows an example of a flow of access control performed in the example of the implementation of the access control system 5000. The user apparatus 2000 detects access to the target file 10 (S202). The user apparatus 2000 transmits a request indicating “the identification information of the target user 40, the reference location stored in the metadata of the target file 10, and the type of detected access” to the file server 50 (S204).

In response to the request, the file server 50 determines whether or not the target user 40 has the access right for the target file 10 (S206). The file server 50 transmits access right information 20 indicating the result of this determination to the user apparatus 2000 (S208). Note that association of “the identification information of the user, the identification information of the file or the directory, and the type of permitted access” is stored in advance in the storage device 52. The file server 50 determines whether or not the target user 40 has the access right by comparing the request received from the user apparatus 2000 with the above-described association stored in the storage device 52. The specific determination method is the same as that described above.

The user apparatus 2000 determines whether or not the target file 10 has the access right by using the access right information 20 received from the file server 50 (S210). When the target file 10 does not have the access right (S210: NO), the user apparatus 2000 notifies an error (S212). On the other hand, when the target file 10 has the access right (S210: Yes), the user apparatus 2000 transmits, to the management server 60, a request containing the encryption key stored in the metadata of the target file 10 (S214).

The management server 60 generates a decryption key from the encryption key contained in the request received from the user apparatus 2000 (S216). Then, the management server 60 transmits key information 30 containing the generated decryption key to the user apparatus 2000 (S218). The user apparatus 2000 decrypts the target file 10 by using the received the key information 30 (S220).

Although the present invention is described above with reference to example embodiments, the present invention is not limited to the above-described example embodiments. Various modifications that can be understood by those skilled in the art can be made to the configuration and details of the present invention within the scope of the invention.

Note that, in the above-described examples, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM, CD-R, CD-R/W, and semiconductor memories (such as mask ROM, PROM (Programmable ROM), EPROM (Erasable PROM), flash ROM, RAM, etc.). Further, the program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The whole or part of the embodiments disclosed above can be described as, but not limited to, the following supplementary notes.

### Supplementary Note 1

A program for causing a computer to perform:

a determination step of acquiring access right information about an access right of a target user for an encrypted target file from a first server apparatus, and thereby determining whether or not the target user has an access right for the target file;

an acquisition step of acquiring key information from a second server apparatus when it is determined that the target user has the access right for the target file, the key information being information used to decrypt the target file; and

a decryption step of decrypting the target file by using the acquired key information,

wherein the computer is neither the first server apparatus nor the second server apparatus.

### Supplementary Note 2

The program described in Supplementary note 1,

wherein the access right of the target user for the target file is defined in association with a reference location, the reference location being a location where the target file was stored in the past, and

wherein in the determination step, it is determined whether or not the target user has the access right for the target file based on the access right associated with the reference location of the target file.

### Supplementary Note 3

The program described in Supplementary note 2,

wherein in the determination step, information indicating identification information of the target user and the reference location of the target file is transmitted to the first server apparatus, and

wherein the access right information indicates a result of a determination made by the first server apparatus as to whether or not the target user has the access right for the reference location.

### Supplementary Note 4

The program described in Supplementary note 2 or 3,

wherein the target file has already been copied or moved from a first directory provided in a storage device of a file server to a second directory provided in a storage device of the computer before the determination step is performed, and

wherein the reference location of the target file is set to the first directory.

### Supplementary Note 5

The program described in Supplementary note 4, wherein the first server apparatus is the file server.

### Supplementary Note 6

The program described in any one of Supplementary notes 1 to 5,

wherein in the acquisition step, performing:
providing an encryption key used for encryption of the target file to the second server apparatus;
acquiring a decryption key of the target file generated from the encryption key as the key information; and

wherein in the decryption step, the target file is decrypted by using the decryption key.

### Supplementary Note 7

A user apparatus comprising:

a determination unit configured to acquire access right information about an access right of a target user for an encrypted target file from a first server apparatus, and thereby determine whether or not the target user has an access right for the target file;

an acquisition unit configured to acquire key information from a second server apparatus when it is determined that the target user has the access right for the target file, the key information being information used to decrypt the target file; and

a decryption unit configured to decrypt the target file by using the acquired key information.

### Supplementary Note 8

The user apparatus described in Supplementary note 7,

wherein the access right of the target user for the target file is defined in association with a reference location, the reference location being a location where the target file was stored in the past, and

wherein the determination unit determines whether or not the target user has the access right for the target file based on the access right associated with the reference location of the target file.

### Supplementary Note 9

The user apparatus described in Supplementary note 8,

wherein the determination unit transmits, to the first server apparatus, information indicating identification information of the target user and the reference location of the target file, and

wherein the access right information indicates a result of a determination made by the first server apparatus as to whether or not the target user has the access right for the reference location.

### Supplementary Note 10

The user apparatus described in Supplementary note 8 or 9,

wherein the target file has already been copied or moved from a first directory provided in a storage device of a file server to a second directory provided in a storage device of the user apparatus before the determination is made by the determination unit, and

wherein the reference location of the target file is set to the first directory.

### Supplementary Note 11

The user apparatus described in Supplementary note 10, wherein the first server apparatus is the file server.

### Supplementary Note 12

The user apparatus described in any one of Supplementary notes 7 to 11,

wherein the acquisition unit performs:
providing an encryption key used for encryption of the target file to the second server apparatus; and
acquiring, as the key information, a decryption key of the target file generated from the encryption key, and

wherein the decryption unit decrypts the target file by using the decryption key.

### Supplementary Note 13

An access control method performed by a computer, comprising:

a determination step of acquiring access right information about an access right of a target user for an encrypted target file from a first server apparatus, and thereby determining whether or not the target user has an access right for the target file;

an acquisition step of acquiring key information from a second server apparatus when it is determined that the target user has the access right for the target file, the key information being information used to decrypt the target file; and

a decryption step of decrypting the target file by using the acquired key information,

wherein the computer is neither the first server apparatus nor the second server apparatus.

### Supplementary Note 14

The access control method described in Supplementary note 13,

wherein the access right of the target user for the target file is defined in association with a reference location, the reference location being a location where the target file was stored in the past, and

wherein in the determination step, it is determined whether or not the target user has the access right for the target file based on the access right associated with the reference location of the target file.

### Supplementary Note 15

The access control method described in Supplementary note 14, wherein

wherein in the determination step, information indicating identification information of the target user and the reference location of the target file is transmitted to the first server apparatus, and

wherein the access right information indicates a result of a determination made by the first server apparatus as to whether or not the target user has the access right for the reference location.

### Supplementary Note 16

The access control method described in Supplementary note 14 or 15,

wherein the target file has already been copied or moved from a first directory provided in a storage device of a file server to a second directory provided in a storage device of the computer before the determination step is performed, and

wherein the reference location of the target file is set to the first directory.

### Supplementary Note 17

The access control method described in Supplementary note 16, wherein the first server apparatus is the file server.

### Supplementary Note 18

The access control method described in any one of Supplementary notes 13 to 17

wherein in the acquisition step, performing:
providing an encryption key used for encryption of the target file to the second server apparatus,
acquiring a decryption key of the target file generated from the encryption key as the key information, and

wherein in the decryption step, the target file is decrypted by using the decryption key.

### Supplementary Note 19

An access control system comprising a user apparatus, a first server apparatus, and a second server apparatus,

wherein the user apparatus comprises:

a determination unit configured to transmit, to the first server apparatus, a first request requesting access right information about an access right of a target user for an encrypted target file, and determine whether or not the target user has the access right for the target file by using the access right information acquired from the first server apparatus;

an acquisition unit configured to transmit, when it is determined that the target user has the access right for the target file, a second request requesting key information to the second server apparatus, and acquire the key information from the second server apparatus, the key information being information used to decrypt the target file; and

a decryption unit configured to decrypt the target file by using the acquired key information, and

wherein the first server apparatus provides the access right information to the user apparatus in response to the first request, and

wherein the second server apparatus provides the key information to the user apparatus in response to the second request.

### Supplementary Note 20

The access control system described in Supplementary note 19,

wherein the access right of the target user for the target file is defined in association with a reference location, the reference location being a location where the target file was stored in the past,

wherein the first request contains identification information of the target user and the reference location of the target file, and

wherein the first server apparatus determines whether or not the target user has the access right for the target file based on the access right associated with the reference location of the target file, and provides the access right information indicating a result of this determination to the user apparatus.

### Supplementary Note 21

The access control system described in Supplementary note 19 or 20,

wherein the second request contains an encryption key used for encryption of the target file, and

wherein the second server apparatus generates a decryption key of the target file from the encryption key contained in the second request, and provides the key information containing the generated decryption key to the user apparatus.

### REFERENCE SIGNS LIST

10 TARGET FILE
20 ACCESS RIGHT INFORMATION
30 KEY INFORMATION
40 TARGET USER
50 FILE SERVER
52 STORAGE DEVICE
60 MANAGEMENT SERVER
70 STORAGE DEVICE
500 COMPUTER
502 BUS
504 PROCESSOR
506 MEMORY
508 STORAGE DEVICE
510 INPUT/OUTPUT INTERFACE
512 NETWORK INTERFACE
2000 USER APPARATUS
2020 DETERMINATION UNIT
2040 ACQUISITION UNIT
2060 DECRYPTION UNIT
3000 FIRST SERVER APPARATUS
4000 SECOND SERVER DEVICE
5000 ACCESS CONTROL SYSTEM

What is claimed is:

1. A non-transitory computer readable medium storing a program that is configured to cause a computer to perform:
acquiring access right information about an access right of a target user for an encrypted target file from a first server apparatus, and thereby determining whether or not the target user has an access right for the target file;
acquiring key information from a second server apparatus when it is determined that the target user has the access right for the target file, the key information being information used to decrypt the target file; and
decrypting the target file by using the acquired key information,
wherein the computer is neither the first server apparatus nor the second server apparatus.

2. The computer readable medium according to claim 1,
wherein the access right of the target user for the target file is defined in association with a reference location, the reference location being a location where the target file was stored in the past, and
wherein whether or not the target user has the access right for the target file is determined based on the access right associated with the reference location of the target file.

3. The computer readable medium according to claim 2,
wherein the program further causes the computer to transmit information indicating identification information of the target user and the reference location of the target file to the first server apparatus, and
wherein the access right information indicates a result of a determination made by the first server apparatus as to whether or not the target user has the access right for the reference location.

4. The computer readable medium according to claim 2,
wherein the target file has already been copied or moved from a first directory provided in a storage device of a file server to a second directory provided in a storage device of the computer before the acquisition of the access right information, and
wherein the reference location of the target file is set to the first directory.

5. The computer readable medium according to claim 4, wherein the first server apparatus is the file server.

6. The computer readable medium according to claim 1,
wherein the acquisition of the key information includes:
providing an encryption key used for encryption of the target file to the second server apparatus;
acquiring a decryption key of the target file generated from the encryption key as the key information; and
wherein the target file is decrypted by using the decryption key.

7. A user apparatus comprising:
at least one memory storing instructions; and
at least one processor that is configured to execute the instructions to:
acquire access right information about an access right of a target user for an encrypted target file from a first server apparatus, and thereby determine whether or not the target user has an access right for the target file;
acquire key information from a second server apparatus when it is determined that the target user has the access right for the target file, the key information being information used to decrypt the target file; and
decrypt the target file by using the acquired key information.

8. The user apparatus according to claim 7,
wherein the access right of the target user for the target file is defined in association with a reference location, the reference location being a location where the target file was stored in the past, and
wherein whether or not the target user has the access right for the target file is determined based on the access right associated with the reference location of the target file.

9. The user apparatus according to claim 8,
wherein the at least one processor is configured further to transmit, to the first server apparatus, information indicating identification information of the target user and the reference location of the target file, and
wherein the access right information indicates a result of a determination made by the first server apparatus as to whether or not the target user has the access right for the reference location.

10. The user apparatus according to claim 8,
wherein the target file has already been copied or moved from a first directory provided in a storage device of a file server to a second directory provided in a storage device of the user apparatus before the acquisition of the access right information, and
wherein the reference location of the target file is set to the first directory.

11. The user apparatus according to claim 10, wherein the first server apparatus is the file server.

12. The user apparatus according to claim 7,
wherein the acquisition of the key information includes:
providing an encryption key used for encryption of the target file to the second server apparatus; and
acquiring, as the key information, a decryption key of the target file generated from the encryption key, and
wherein the target file is decrypted by using the decryption key.

13. An access control method performed by a computer, comprising:
acquiring access right information about an access right of a target user for an encrypted target file from a first server apparatus, and thereby determining whether or not the target user has an access right for the target file;
acquiring key information from a second server apparatus when it is determined that the target user has the access right for the target file, the key information being information used to decrypt the target file; and
decrypting the target file by using the acquired key information,
wherein the computer is neither the first server apparatus nor the second server apparatus.

14. The access control method according to claim 13,
wherein the access right of the target user for the target file is defined in association with a reference location, the reference location being a location where the target file was stored in the past, and
wherein whether or not the target user has the access right for the target file is determined based on the access right associated with the reference location of the target file.

15. The access control method according to claim 14, further comprising:
transmitting information indicating identification information of the target user and the reference location of the target file the first server apparatus, and
wherein the access right information indicates a result of a determination made by the first server apparatus as to whether or not the target user has the access right for the reference location.

16. The access control method according to claim 14,
wherein the target file has already been copied or moved from a first directory provided in a storage device of a file server to a second directory provided in a storage device of the computer before the acquisition of the access right information, and
wherein the reference location of the target file is set to the first directory.

17. The access control method according to claim 16, wherein the first server apparatus is the file server.

18. The access control method according to claim 13,
wherein the acquisition of the key information includes:
providing an encryption key used for encryption of the target file to the second server apparatus,
acquiring a decryption key of the target file generated from the encryption key as the key information, and
wherein the target file is decrypted by using the decryption key.

19. An access control system comprising a user apparatus, a first server apparatus, and a second server apparatus,
wherein the user apparatus comprises at least one memory storing instructions and at least one processor that is configured to execute the instructions to:
transmit, to the first server apparatus, a first request requesting access right information about an access right of a target user for an encrypted target file, and determine whether or not the target user has the access right for the target file by using the access right information acquired from the first server apparatus;
transmit, when it is determined that the target user has the access right for the target file, a second request requesting key information to the second server apparatus, and acquire the key information from the second server apparatus, the key information being information used to decrypt the target file; and
decrypt the target file by using the acquired key information, and
wherein the first server apparatus provides the access right information to the user apparatus in response to the first request, and
wherein the second server apparatus provides the key information to the user apparatus in response to the second request.

20. The access control system according to claim 19,
wherein the access right of the target user for the target file is defined in association with a reference location, the reference location being a location where the target file was stored in the past,
wherein the first request contains identification information of the target user and the reference location of the target file, and
wherein the first server apparatus determines whether or not the target user has the access right for the target file based on the access right associated with the reference location of the target file, and provides the access right information indicating a result of this determination to the user apparatus.

21. The access control system according to claim 19,
wherein the second request contains an encryption key used for encryption of the target file, and
wherein the second server apparatus generates a decryption key of the target file from the encryption key contained in the second request, and provides the key information containing the generated decryption key to the user apparatus.
